(19) United States
(12) Patent Application Publication
(10) Pub. No.: US 2022/0114455 A1
(43) Pub. Date: Apr. 14, 2022

(54) PRUNING AND/OR QUANTIZING MACHINE LEARNING PREDICTORS

(71) Applicant: Fraunhofer-Gesellschaft zur Foerderung der angewandten Forschung e.V., Munich (DE)

(72) Inventors: Wojciech SAMEK, Berlin (DE); Sebastian LAPUSCHKIN, Berlin (DE); Simon WIEDEMANN, Berlin (DE); Philipp SEEGERER, Berlin (DE); Seul-Ki YEOM, Berlin (DE); Klaus-Robert MUELLER, Berlin (DE); Thomas WIEGAND, Berlin (DE)

(21) Appl. No.: 17/556,657

(22) Filed: Dec. 20, 2021

Related U.S. Application Data
(63) Continuation of application No. PCT/EP2020/068134, filed on Jun. 26, 2020.

(30) Foreign Application Priority Data
Jun. 26, 2019 (EP) 19182598.3

(51) Int. Cl. G06N 3/08; G06N 5/04; G06K 9/62

(52) U.S. Cl. CPC G06N 3/082; G06K 9/6223; G06N 5/04

(57) ABSTRACT

Pruning and/or quantizing a machine learning predictor or, in other words, a machine learning model such as a neural network is rendered more efficient if the pruning and/or quantizing is performed using relevance scores which are determined for portions of the machine learning predictor on the basis of an activation of the portions of the machine learning predictor manifesting itself in one or more inferences performed by the machine learning (ML) predictor.

### CROSS-REFERENCES TO RELATED APPLICATIONS

This application is a continuation of copending International Application No. PCT/EP2020/068134, filed Jun. 26, 2020, which is incorporated herein by reference in its entirety, and additionally claims priority from European Application No. EP 19182598.3, filed Jun. 26, 2019, which is incorporated herein by reference in its entirety.

The present application relates to concepts for pruning and/or quantizing machine learning predictors.

### BACKGROUND OF THE INVENTION

Complex neural network type models can be considered the state of the art of modern machine learning. The typical procedure of training neural networks (and other machine learning models) consists of the initialization of a model architecture, followed by a optimization of the model parameters populating that architecture, based on corpora of training data. While the choice of model architecture determines the possible capacity of a machine learning model to (learn to) solve a posed prediction problem, it might be the case that this capacity is not fully required when using the model for inference after training. This is the case when the model has learned to propagate information sparsely throughout its architecture in order to solve the posed problem (i.e. some dimension/nodes or connections within the model graph are unused or rarely used to considerable effect) or a user is not interested in the model's full array of possible outputs (e.g. the user only has use for 2 out of 10 available network outputs) and thus problem solving capabilities. In both cases, (large) parts of the model might be redundant wrt to its application scenario. However, those redundant parts of the model will still occupy valuable space on disk for storage and in system memory during application. At the same time, information will be processed throughout the redundant parts of the model, increasing the number of floating point operations (FLOPS) and thus runtime and energy that may be used for inference, oftentimes far beyond the optimal minimum.

Current network pruning techniques make weights or channels sparse by removing some non-informative connections and are mostly designed to eliminate connections between neurons according to a specific criterion. Thus, it is very crucial to accurately select a highly irrelevant subset of model parameters (i.e. nodes or (filter) channels) for deletion without sacrificing performance.

In previous studies, choices regarding the significant selection of irrelevant model elements have been made based on the magnitude of its (1) Taylor expansion or derivative, (2) gradients, (3) weights, or (4) other criteria.

For example, early approaches towards neural network pruning—optimal brain damage [12] and optimal brain surgeon [7] leveraged a second-order Taylor expansion based on the Hessian matrix of the loss function to select parameters for deletion.

The work of [14] uses Taylor expansion as a criterion to approximate the change of loss in the objective function as an effect of pruning away network elements.

A minimal effort backpropagation approach proposed in [17] makes use of the magnitude of the gradient from training in order to identify non-essential features in MLP and LSTM type models.

More recent approaches concentrate on pruning non-essential and redundant (and individual) weights from models [6, 18], or whole filters/channels [13] by selecting (on average) smaller weights (which fall under a preset threshold, after optionally normalizing the weight matrices beforehand), following the assumption that those filters will produce (on average) weaker output activations.

The work of [9] directly selects features by (average) output activation strength or high counts of zero-activations

A technique which alternates between LASSO regression-based channel selection and feature map reconstruction to prune filters has been proposed in [8].

[1] proposes structured pruning in convolutional layers by considering strided sparsity of feature maps and kernels to avoid the need for custom hardware and uses particle filters to determine the importance of connections and paths.

The work in [20] proposes the Neuron Importance Score Propagation (NISP) algorithm to propagate the importance scores of model output responses before the softmax layer towards previous layers. The method is based on a layer-independent pruning process which does not consider global relative neural network element importance ratings.

It would be advantageous to have a concept at hand which renders pruning and/or quantizing machine learning predictors or, alternatively speaking, machine learning models more efficient such as more efficient in terms of conservation of inference quality with reducing, concurrently, computational inference complexity, complexity of describing or storing the parameterization of the respective machine learning predictor, or which even improves the inference quality for a certain task at hand and/or for a certain local input data statistic.

### SUMMARY

An embodiment may have an apparatus for pruning and/or quantizing of a machine learning (ML) predictor, the apparatus being configured to determine relevance scores for portions of the ML predictor on the basis of an activation of the portions of the ML predictor manifesting itself in one or more inferences performed by the ML predictor, prune and/or quantize the ML predictor using the relevance scores.

According to another embodiment, a method for pruning and/or quantizing of a machine learning (ML) predictor may have the steps of: determining relevance scores for portions of the ML predictor on the basis of an activation of the portions of the ML predictor manifesting itself in one or more inferences performed by the ML predictor, pruning and/or quantizing the ML predictor using the relevance scores.

According to yet another embodiment, a non-transitory digital storage medium may have a computer program stored thereon to perform the inventive method, when said computer program is run by a computer.

It is a basic idea underlying the present application that pruning and/or quantizing a machine learning predictor or, in other words, a machine learning model such as a neural network may be rendered more efficient if the pruning and/or quantizing is performed using relevance scores which are determined for portions of the machine learning predictor on the basis of an activation of the portions of the machine learning predictor manifesting itself in one or more inferences performed by the machine learning (ML) predictor.

In particular, using relevance scores as a basis for pruning and/or quantizing turns out to efficiently guide the pruning and/or quantizing concept in terms of weighing-up between pruning and/or quantizing too coarsely on the one hand and achieving a considerable amount of reduction of the ML predictor complexity on the other hand such as complexity in terms of the actual appliance of the ML predictor or, alternatively speaking, in terms of computational complexity of the actual inference task or in terms of predictor/model description such as in terms of a size of the parameterization data for parameterizing the ML predictor. Alternatively, the concept lends itself for an efficient adaptation of an existing ML predictor for a specific/local training data or tailoring an existing ML predictor for a certain subtask.

In accordance with an aspect of the present application, the relevance score determination and pruning and/or quantizing are recursively repeated. That is, after a first round of relevance score determination and pruning and/or quantizing using the determined relevance scores, the pruned and/or quantized version of the ML predictor is used as a starting point for a following round. That is, the pruned and/or quantized version of the ML predictor is subject to, or used to perform one or more further inferences. Based on these one more further inferences, further relevance scores are determined and the pruning and/or quantizing result of the predecessor round of the ML predictor is again subject to pruning and/or quantizing using the further relevance scores. Any abort criterion may be used in order to determine the number of rounds thus performed.

Additionally or alternatively, a non-pruned-away and/or non-quantized to zero portion of the ML predictor as resulting from the pruning and/or quantizing is subject to training using training data. For instance, pruned away and/or quantized to zero portions of the ML predictor may be left pruned away and/or quantized to zero in the training with the training, however, enabling that negative effects of the pruning and/or quantizing to zero on the inference quality are, at least partially, redone or compensated.

In accordance with an embodiment of the present application, the ML predictor which may be, or may comprise, an ML network such as a neural network comprises nodes and node interconnections and the relevance scores may be determined for nodes and/or node interconnections of the ML predictor. In particular, in accordance with an embodiment, the relevance score determination is done by back propagating an initial relevance score at an output node of the ML predictor which may be set depending on an output activation manifesting itself at the output node of the ML predictor in one or more inferences towards input nodes of the ML predictor such as to a scaled version of that output activation, or which may be set to a default output value. In doing so, a relevance score at a predetermined node of the ML predictor is distributed onto predecessor nodes of the predetermined node according to fractions which correspond to further fractions at which activations of the predecessor nodes contribute to an activation of the predetermined node in the one or more inferences. Doing so yields a relevance score which efficiently measures a detrimental impact which a pruning and/or quantizing of the nodes and/or node interconnections would have on a quality or accuracy of the inference/prediction results. Furthermore, performing the distribution of the relevance score from a predetermined node onto its predecessor nodes according to fractions which are adapted to the relative intensity of activations of these predecessor nodes towards the predetermined node in the one or more inferences enables to achieve certain characteristics of the achieved relevance score measure such as the global comparability between the individual relevance scores globally over the ML network. By this measure, it is possible to measure the aforementioned detrimental impact in a manner which lowers the danger of accidentally focusing pruning and/or quantization at certain portions of the ML network owing to the usage of a measure which locally varies.

Further, distributing the relevance score in such a manner enables to form aggregations of relevance scores of certain portions of the ML network so as to promote in the pruning and/or quantizing step the achievement of a ML network which is even more efficient in terms of computational inference complexity.

In case of pruning, this pruning is, in accordance with an embodiment of the present application, done by thresholding. Predetermined portions of the ML predictor whose relevance according to the relevance score determined for the predetermined portions is lower than a predetermined threshold, are pruned away. Alternatively, a ranking among portions of the ML predictor according to their relevance scores may be performed with pruning away those portions belonging to a predetermined fraction of lowest-relevance portions of the ML predictor. In addition to pruning away portions of the ML predictor whose relevance according to the relevance score determined for the predetermined nodes fulfills a predetermined criterion, further portions may be pruned away which contribute to an output of the ML predictor via the former portions exclusively, thereby having become “superfluous”. The pruning may, in accordance with an embodiment of the present application, being heuristically guided by decreasing, for instance, the aforementioned predetermined threshold used in thresholding for pruning the ML predictor towards an output of the ML predictor.

In accordance with an even further embodiment of the present application, however, the pruning and/or quantizing the ML predictor using the relevance scores determined for portions of the ML predictor is done using an optimization scheme such as k-means clustering. Here, the optimization scheme is performed using an objective function which depends on a weighted distance between quantized weights and unquantized weights of the ML predictor, weighted based on the relevance scores. For instance, the ML predictor may be an ML network such as a neural network and the weights which connect the network nodes, i.e., the weights associated with the network node interconnections, and which determine, multiplicatively, the extent at which the activation of a certain network node is propagated to a certain successor node during inference, are subject, for instance, to quantization and the quantization error is measured using the just-mentioned weighted distance. This avoids quantization of weights whose relevance scores, i.e., relevance scores having been assigned to the corresponding network node interconnection, is larger, compared to weights whose relevance scores are lower.

In accordance with an embodiment, the objective function depends on a sum of the weighted distance on the one hand and a code length of a representation of the quantized weights on the other hand such as minus a logarithm of the probability of the quantized weights, with the probability measured for instance by the relative frequency of the quantized weights, thereby achieving that the optimization scheme focuses their quantized weights onto a lower number of quantization levels. The logarithm of base 2 may be used to this end.

In accordance with the embodiment, the pruning and/or quantizing is applied onto an ML predictor retrieved from a server which is then applied onto local input data so as make the ML predictor retrieved from the server performing the one or more inferences. By this measure, the pruned and/or quantized version of the ML predictor may be used to replace the ML predictor and used to perform further inferences onto further input data. Interestingly, the resulting pruned and/or quantized version of the ML predictor, so not having been subject to a local training for the local input data, and though being rendered more efficient in terms of computational and/or descriptive characteristics, tends to yield better results for the local statistics underlying the local input data due to the adaptation to the local input data via the one or more inferences having been obtained on the basis of the local input data.

In accordance with an even further embodiment, the pruning and/or quantizing may be performed on a ML predictor which has been obtained from a general ML predictor retrieved, for instance, from a server, by removing portions of the general ML predictor which are exclusively interconnected to one or more predetermined uninterested outputs of the ML predictor. Again, no complete new training is done, but nevertheless for the subtask associated with the subset of outputs of the general ML predictor, a more efficient and sometimes even more accurate ML predictor is achieved by the pruning and/or quantizing without training on the local data statistic being necessary.

### BRIEF DESCRIPTION OF THE DRAWINGS

Embodiments of the present invention will be detailed subsequently referring to the appended drawings, in which:

FIG. 1 shows a schematic diagram illustrating an ML predictor, the figure also serving as a basis for explaining relevance score determination;

FIG. 2 shows a schematic block diagram illustrating an apparatus for pruning and/or quantizing an ML predictor in accordance with an embodiment of the present application;

FIGS. 3a-3c show schematic diagrams of layered ML predictor or network as an example for an ML predictor and illustrate relevance score determination for pruning.

FIG. 3a illustrates the evaluation of relevance of weighted connections and network nodes such as neurons using relevance score determination with the relevance scores for nodes being denoted by R_{⋅} and the relevance scores assigned to node interconnections being indicated by R_{⋅←⋅};

FIG. 3b illustrates a structure pruning example where architecture which effects model elements, here exemplarily nodes, are removed, including the removal of attached connections or connections having become redundant;

FIG. 3c illustrates unstructured pruning of individual (weighted) connections along with an optional succeeding structured pruning step;

FIGS. 4a-4b again illustrate a schematic diagram of an ML predictor wherein FIG. 4a aims at illustrating unstructured pruning of irrelevant (weighted) connections within one transformation layer of the model, whereas FIG. 4b illustrates a follow-up structured pruning step as logical next step to increase model efficiency without altering its functionality;

FIG. 5 shows schematically the definition of a layered ML predictor such as a neural network by way of defining the interconnections between two layers of nodes of the ML predictor by way of a mapping function such as a weight matrix with additionally illustrating examples for structured pruning of individual model components, including weights or mapping paths—mapping routes from component i of the input to component j of the adjacent output —, in order to show that pruning of such weights or mapping paths in a structured manner is considered as structured pruning;

FIG. 6 shows a pseudo code of a k-means algorithm using a relevance score improved cost function for quantizing an ML predictor in accordance with an embodiment.

### DETAILED DESCRIPTION OF THE INVENTION

The following description of embodiments of the present application starts with a brief introduction and outline of embodiments of the present application in order to explain their advantages and how same achieve these advantages. During this brief outline, exemplary implementations for relevance score determination are presented and their advantages in pruning and/or quantizing machine learning predictors are set out. Thereinafter, possible embodiments making use of the advantageous aspects initially set out are presented. In between, generalizing embodiments are described in order to avoid the impression the present application was restricted to specific sorts of ML predictors or specific relevance score determination examples.

As already mentioned above, the present application is concerned with pruning and/or quantizing ML predictors or, differently speaking, ML models. Such ML predictors may be neural networks or other graph-shaped machine learning models such as feature extraction pipelines comprising mapping functions with a terminating prediction function. The pruning and/or quantizing may, for instance, aim at minimizing the amount of FLOPS (floating point operations per second) involved in inference, i.e., involved in applying the ML predictor to a certain input for performing a prediction task, and space that may be used for model representation, i.e., involved in storing its parameterization, for instance.

In other words, some embodiments of the present application aim at removing redundant or irrelevant elements from the ML predictor. The “elements” may relate to (weighted) connections, a node of the ML predictor, a neuron, a dimension of intermediate representations and corresponding model parameters, or mapping paths, possibilities or relationships between nodes, neurons and dimensions of intermediate representations. The removal may aim at reducing the number of FLOPS that may be used when using the model for inference while minimizing negative effects on the model performance with respect to a desired inference task. Additionally or alternatively, pruning may aim at a removal of redundant or irrelevant elements from an ML predictor in order to reduce the description of a length of the model such as for reducing the memory footprint on disk or in system RAM (random access memory), while minimizing negative effects on model performance with respect to a desired inference task. The same or similar aims may be associated with embodiments of the present application targeting a quantization of an ML predictor.

In order to identify which elements of the ML predictor to prune away and/or quantize, or, differently speaking, to identify which elements of the model are not, or are not so, relevant for solving a problem or, to be more precise, for performing the prediction or inference accurately, an appropriate measure is used in accordance with the embodiments described further below. In particular, the embodiments described below employ a measure or quantity of “relevance”. Such relevance is, for instance, computed with and defined in the context of layer-wise relevance propagation [2] as a measure of interaction of the model with given input data. Depending on the practical implication, these quantities of relevance corresponding to an element of the machine learning model/predictor can be aggregated over multiple data points, or be based on individual samples. This manner of identifying the vital elements of an ML predictor constitutes a basis of the subsequent actual pruning and/or quantization of the ML predictor.

As will be outlined in more detail below, the identification of parts of an ML predictor or model architecture which are relevant to the solution of a problem at hand or, differently speaking, for performing the prediction/inference, enables an additional scenario for the application of model pruning and/or quantization: assume a setting where a very generally pre-trained model exists such as an ImageNet predictor, which has been trained to solve a task related to its destined application, and the user is lacking the useful amounts of training data for successfully fine-tuning the model towards solving the task at hand. However, a comparatively low number of exemplary validation samples exists for the intended task. By pruning away or quantizing to zero paths from the original model strategically, one could obtain a model proficient at solving the intended task, or sub-tasks thereof. Details in this regard are further outlined below.

Let's now turn to the task of relevance score determination. As already outlined, the relevance score serves as a criterion for pruning and/or quantizing ML predictor portions or ML predictor elements such as neural network elements, wherein this relevance score or relevance quantity may be computed with LRP as described in [2] such as by applying relevance decomposition rules suitable for a model architecture at hand [11]. The relevance decomposition process for a given sample may described as a process proportional to forward activations propagated through the ML predictor, as computed from a given input to the ML predictor. During the forward paths, i.e., during the actual inference or prediction process, through the ML predictor or ML model, an activation of an element j at a layer l of the model is determined by inputs from preceding elements indexed by i, located at layer l. We refer to these inputs, directed from some element i at layer l towards a successor j at layer l+1 as quantities zᵢⱼ. These quantities can be the result of some mapping operation (e.g. the multiplication of a layer input xᵢ with a weight w₁₁, as commonly found in neural networks: zᵢⱼ=wᵢⱼxᵢ, or an arbitrary, potentially non-linear mapping function mᵢⱼ(x) performing a mapping (for one or all components i) from an input x towards the mapping output(s) j, such as they are commonly found in Bag of Words or Bag of Feature-based prediction pipelines: zᵢⱼ=mᵢⱼ(xᵢ)) then are then aggregated—e.g. by summation or max-pooling—at element j, resulting in an activation zⱼ.

We can assume some given upstream relevance quantity Rⱼ^{(l+1)} at a layer l and a model element indexed by j (here; nodes, neurons or dimensions). The given upstream relevance value can be the end result of an application of LRP in higher layers, or the initialization of the algorithm with the or a model output of interest, e.g. Rⱼ^{(l+1)}=fⱼ(x), or a scaled version of the model output, or some meaningfully/heuristically chosen initial value for Rⱼ.

For relevance score determination, an upstream relevance value Rⱼ^{(l+1)} is then decomposed towards predecessor elements i in proportion to the quantities zᵢⱼ propagated from i to j, causing the activation of j. This decomposition process results in backwards directed relevance messages corresponding to one z₁₁ each:

$${R}_{i ← j}^{( l , l + 1 )} = \frac{{z}_{ij}}{{z}_{j}} {R}_{j}^{( l + 1 )} \qquad ( 1 )$$

Above equation (1) describes the most basic decomposition rule of LRP. Other, advanced and purposed decomposition rules and corresponding application cases (that is, specific neural network layers or other mapping functions) may be found in corresponding literature, e.g. [11] or related publications.
The relevance of a model element i at some layer l is then simply the aggregation of all incoming messages R_{i←j}^{(l,l+1)}:

Rᵢ^{(l)}=ΣⱼR_{i←j}^{(l,l+1)} (2)

Note that above decomposition formula (1) is locally conservative, i.e. no quantity of relevance gets lost or injected during the distribution of Rⱼ^{(l+1)} among R_{i←j}^{(l,l+1)}, which acts as a natural normalization step of relevance wrt layer size. This means that the actual value of relevance attributed to an element of the model actually reflects the elements' relative importance to the whole model. That is, by using LRP, we can use one pruning criterion for the entire model. In contrast, other pruning methods involve different pruning criteria for different parts of the network.

As such, the relevance values obtained from LRP naturally act as a global measure of model element importance and can thus be used for globally selecting model elements for pruning. However, note that the use of relevance scores is not restricted to a global application of pruning. Note that different strategies for selecting (sub-)parts of the model might still be considered, e.g. applying different weightings/priorities for pruning different parts of the model: Should the aim of the pruning operation for example be the reduction of FLOPS that may be used during inference, one would prefer to focus on pruning elements from the convolutional layers of the network first, without altering higher layers at all.

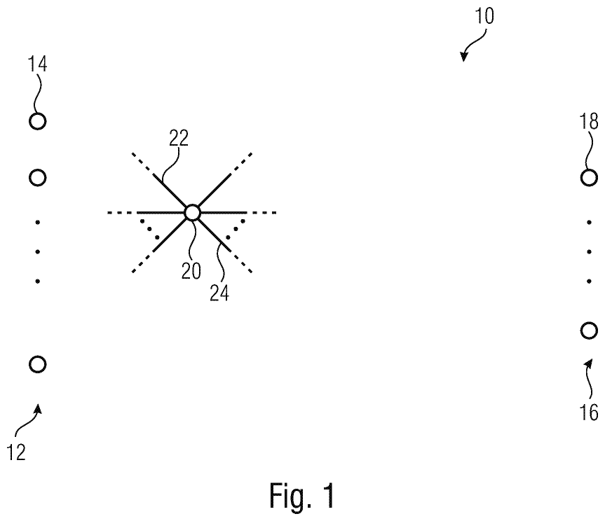

Let's briefly interrupt the presentation and description of LRP as an example for relevance score determination. Reference is made to FIG. 1. In particular, FIG. 1 shows an ML predictor 10 comprising an input interface 12 with input nodes or elements 14 and an output interface 16 with output nodes or elements 18. The input nodes/elements 14 receive the input data. In other words, the input data is applied thereonto. For instance, as outlined in more detail below, they may receive a picture with, for instance, each element 14 being associated with a pixel of the picture. Alternatively, the input data applied onto elements 14 may be a signal such as a one dimensional signal such as an audio signal, a sensor signal or the like. Even alternatively, the input data may represent a certain data set such as medical file data or the like. As mentioned, examples are set out below. The number of input elements 14 may be any number and depends on the type of input data, for instance. The number of output nodes 18 may be one or larger than one. Each output node or element 18 may be associated with a certain inference or prediction task. In particular, upon the ML predictor 10 being applied onto a certain input applied onto the ML predictor's 10 input interface 12, the ML predictor 10 outputs at the output interface 16 the inference or prediction result wherein the activation resulting at each output node 18 may be indicative, for instance, of an answer to a certain question on the input data such as whether or not, or how likely, the input data has a certain characteristic such as whether a picture having been input contains a certain object such as a car, a person, a phase or the like. Further examples are set out hereinbelow.

Insofar, the input applied onto the input interface may also be interpreted as an activation, namely an activation applied onto each input node or element 14.

Between the input nodes 14 and output node(s) 18, the ML predictor 10 comprises further elements or nodes 20 which are, via connections 22 connected to predecessor nodes so as to receive activations from these predecessor nodes, and via one or more further connections 24 to successor nodes in order to forward to the successor nodes the activation of node 20.

Predecessor nodes may be other internal nodes 20 of the ML predictor 10, via which intermediate node 20 exemplarily depicted in FIG. 1 is indirectly connected to input nodes 14, or may be an input node 14 directly, and the successor nodes may be other intermediate nodes of the ML predictor 10, via which the exemplarily shown intermediate node 20 is connected to the output interface or output node, or may be an output node 28 directly.

The input nodes 14, output nodes 18 and internal nodes 20 of ML predictor 10 may be associated or attributed to certain layers of the ML predictor 10, but a layered structuring of the ML predictor 10 is optional and ML predictors onto which embodiments of the present application apply are not restricted to such layered networks. As far as the exemplary shown intermediate node 20 of ML predictor 10 is concerned, same contributes to the inference or prediction task of ML predictor 10 by forwarding activations from the predecessor nodes received via connections 22 from input interface 12 via connections 24 to successor nodes towards output interface 16. In doing so, node or element 20 computes its activation forwarded via connections 24 towards the successor nodes based on the activations at the input nodes 22 and the computation involves the computation of a weighted sum namely a sum having an addend for each connection 22 which, in turn, is a product between the input received from a respective predecessor node, namely its activation, and a weight associated with the connection 22 connecting the respective predecessor node and intermediate node 20. Note that alternatively or more generally, the activation x forwarded via connections 24 from a node or element i, 20, towards the successor nodes j by way of a mapping function mᵢⱼ(x). Thus, each connection 22 as well as 24 may have a certain weight associated therewith, or alternatively, the result of mapping function mᵢⱼ. Further parameters may be involved in the computation in the activation output by node 20 towards a certain successor node, optionally. In order to determine relevance scores for portions of the ML predictor 10, as described above, activations resulting at an output node 18 upon having finished a certain prediction or inference task on a certain input that the input interface 12 may be used, or a predefined or interesting output activation of interest. This activation at each output node 18 is used as starting point for the relevance score determination, and the relevance is back propagated towards the input interface 12. In particular, at each node of ML predictor 10, such as node 20, the relevance score is distributed towards the predecessor nodes such as via connections 22 in case of node 20, distributed in a manner proportional to the aforementioned products associated with each predecessor node and contributing, via the weighted summation, to the activation of the current node the activation of which is to be backward propagated such as node 20. That is, the relevance fraction back propagated from a certain node such as node 20 to a certain predecessor node thereof may be computed by multiplying the relevance of that node with a factor depending on a ratio between the activation received from that predecessor node times the weight using which the activation has contributed to the aforementioned sum of the respective node, divided by a value depending on a sum of all products between the activations of the predecessor nodes and the weights at which these activations have contributed to the weighted sum of the current node the relevance of which is to be back propagated.

In the manner described above, relevance scores for portions of the ML predictor 10 are determined on the basis of an activation of these portions as manifesting itself in one or more inferences performed by the ML predictor. The “portions” for which such a relevance score is determined may, as discussed above, be nodes or elements of the predictor 10 wherein, again it should be noted that the ML predictor 10 is not restricted to any layered ML network so that, for instance, the element 20, for instance, may be any computation of an intermediate value as computed during the inference or prediction performed by predictor 10. For instance, in the manner discussed above, the relevance score for element or node 20 is computed by aggregating or summing up the inbound relevance messages this node or element 20 receives from its successor nodes/elements which, in turn, distribute their relevance scores in the manner outlined above representatively with respect to node 20. The “portions” for which the relevance scores are determined may, however, alternatively or additionally comprise connections such as connections 22 and 24. Further, additionally or alternatively “portions” for which relevance scores are determined may comprise groups of the just-mentioned entities, elements/nodes and connections, of the ML predictor 10 such as certain sections, layers or otherwise inter-linked (via connections 22 and 24) sections of the architecture of the ML predictor 10. The portions may even be determined on the basis of relevance scores determined at node and/or connection level, i.e. for each node/connection, in order to determine portions which form, in terms of relevance, inter-related architectural structures. Examples are set out below.

In summary, using relevance scores such as LRP provides a series of desirable properties for pruning machine learning models:
Relevance (e.g., in equation (2) and (1)) may be signed, meaning it provides information about important (positive), unimportant (close to zero) and contradicting or negatively important model elements.
It has been shown that relevance scores LRP is a capable method of the “explainable AI” field, able to pin-point important information (in input space, and hidden representations) used for the decision making of a machine learning model [16].
Relevance scores LRP is applicable to a wide range of different models and architectures, which does not restrict our pruning approach to (specific kinds of) neural networks.
Relevance scores LRP is not only able to procure importance scores for individual model nodes/neurons and (by aggregation) filters, but also for the connections between those elements, e.g. the weights or connection, of a neural network model.
Due to the very general nature of relevance scores such as the formulation of LRP, it can be applied to all kinds of layers (pooling . . . ), kernel- and mapping functions.
Relevance scores LRP is conservative between layers, which means that there is no need for additional lₚ based normalization of importance scores within layers. LRP adapts to the depth/width of filters and neuron tensors automatically, making global network pruning possible, e.g. by identifying and preserving information bottlenecks.
One can configure relevance scores LRP to resort to model-optimal parameters (see i.e. [10, 11]) or to focus the end result of the pruning to achieve specific goals.
Computing relevance criterions scales with the sample size n used for estimating model element importance. Still, the computational effort involved can be upper-bounded to n·O(f(x)).

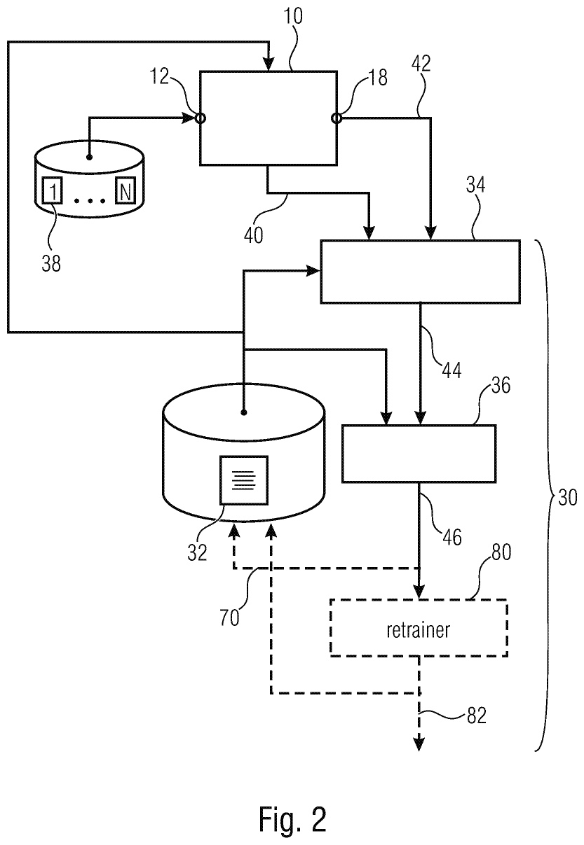

As already indicated above, in accordance with embodiments of the present application, the relevance scores determined as outlined above, are used in order to efficiently prune and/or quantize the ML predictor 10. FIG. 2 shows an apparatus for pruning and/or quantizing an ML predictor 10, the apparatus being indicated using reference sign 30. The apparatus 30 comprises access to a description or a representation 32 of the ML predictor 10 such as information about the architecture thereof, the interconnections between nodes/elements thereof, the rates associated with the connections to mention a few examples thereof. The apparatus may comprise a memory for storing the representation 32 as illustrated in FIG. 2.

Further, the apparatus 30 comprises a relevance score determinator 34 and a processor 36 for performing the actual pruning and/or quantization.

In particular, the relevance score determinator 34 has access to the activations of portions of the ML predictor 10 as manifesting themselves at the time of applying the ML predictor onto one or more input data items 38 which might, as illustrated in FIG. 2, also stored on a memory, such as access to the activations manifesting themselves at intermediate nodes 20 and/or connections 22, 24 of the ML predictor 10, indicated by 40 in FIG. 2, and/or the activation and/or output 42 at the output node(s) 18 of the ML predictor. Based on these activations, the relevance score determinator 34 determines the relevance scores for portions of the ML predictor 10. That is, the relevance scores 44, thus determined, relate to a current architecture and parameterization of the ML predictor 10 as indicated by the description 32. As outlined above, the relevance score determinator 34 may have access to description or representation 32 such as the connection weights for performing the relevance score determination. The processor 36 receives the relevance scores 44 and has access to representation 32 and performs the actual pruning and/or quantization of the ML predictor 10 or, alternatively speaking, the pruning and/or quantization of its representation 32, thereby yielding a pruned and/or quantized ML predictor 46 or the representation of such pruned and/or quantized ML predictor 46.

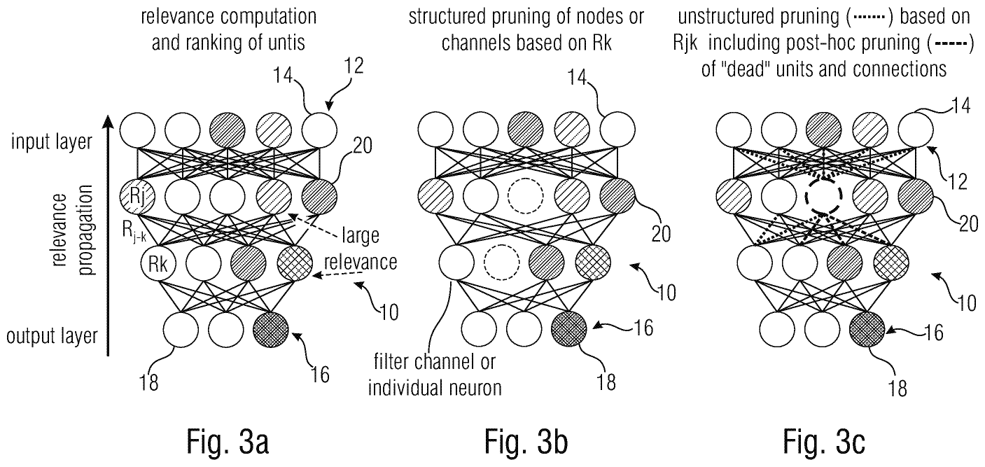

We differentiate between structured and unstructured pruning approaches, which can be used in combination or can be applied as the logical (and efficient) consequence of one another. FIG. 3a-3c aims to provide a brief juxtaposition of both approaches.

FIGS. 3a to 3c show an example for an ML predictor 10 and, by way of differently dense shading of the nodes 14, 20 and 18 thereof, the relevance scores determined for same. The denser the shading of a node is, the larger is its relevance score. In particular, the relevance scores thus illustrated in FIGS. 3a and 3b are the result of determining the relevance scores on the basis of the activations manifesting themselves at the time of applying the ML predictor 10 onto one or more input examples using an initial representation or description of the ML predictor 10. FIG. 3b shows, by way of dashed lines of some nodes namely here exemplarily internal nodes 20, that some portions, here these nodes shown by dashed lines, have been pruned away due to their low relevance scores assigned thereto. FIG. 3c shows a similar result of pruning away certain portions of the ML predictor 10, but this time the pruning pertains to individual interconnections between nodes, and nodes are pruned away only by way of a subsequent clean-up step wherein nodes are removed whose activations cannot participate in the inference as they are disconnected from input interface 12 and/or out interface 16 due to all connections leading upstream and/or downstream having been pruned away. Here, exemplarily an intermediate node 20 is shown as being removed in this manner. The difference between the pruning according to FIG. 3b and FIG. 3c lies in the selection of the portions for which relevance scores are determined and at which the decision whether certain portions of the ML predictor 10 shall be pruned away or not, is made. In case of FIG. 3b, the portions denote certain nodes or channels. That is, the pruning is done based on relevance scores assigned to nodes or collections of nodes. In case of FIG. 3c, the portions subject to the pruning decision relate to the individual connections of the ML predictor. That is, individual connections of the ML predictor 10 may be pruned away relative to the connections present in the representation 32 of the ML predictor 10 as depicted in FIG. 3a, and merely as a subsequent step, as a post-hoc pruning step, elements or nodes which do no longer play a role in the inference/prediction because they are either unconnected to the output 16 or unconnected to the input 14 are also pruned away.

The two types of pruning are presented in more detail below.

Unstructured model pruning describes the elimination of individual parameters of the model without affecting the overall structure or architecture of the model. An example would be the pruning of unimportant weight connections in neural network type architectures, compare [18]. Here, the relevance quantities R_{i←j}^{(l,l+1)} as defined in equation (1) act as pruning criterion or importance ratings; that is, the relevance score determinator 34 of FIG. 2, when performing the relevance score determination based on activations as manifesting themselves in inferences/predictions performed by the ML predictor 10 on more than one input examples 38, may derive the finally used relevance scores 44 to be forwarded to processor 36, by some sort of aggregating, summation and/or averaging of the relevance scores associated with a certain portion of the ML predictor 10 and manifesting themselves in different ones of the inferences/predictions; a statistical analysis may be performed.
Pruning criteria can be aggregations (e.g. sum, avg, max, abs.) over multiple given sample inputs
The filtering of only positively or negatively signed criteria might be desirable in order to achieve specific effects during the pruning process.

An unstructured pruning approach considers a post hoc structured pruning step, e.g. when unstructured pruning results in “dead” model elements (nodes, dimensions, neurons) without outputs to successors or model elements cannot contribute activations (other than 0, for example) anymore, and thus can be safely removed without altering the model's output behavior.

Unstructured pruning may be applied to neural networks or other model types with fixed parameterization (e.g. weights) at transitions between architecture defining model elements (nodes, neurons, dimensions). In case of using interconnections functions m, an application of unstructured pruning for a function m can be realized by ignoring specific mapping input-output pairs i,j.

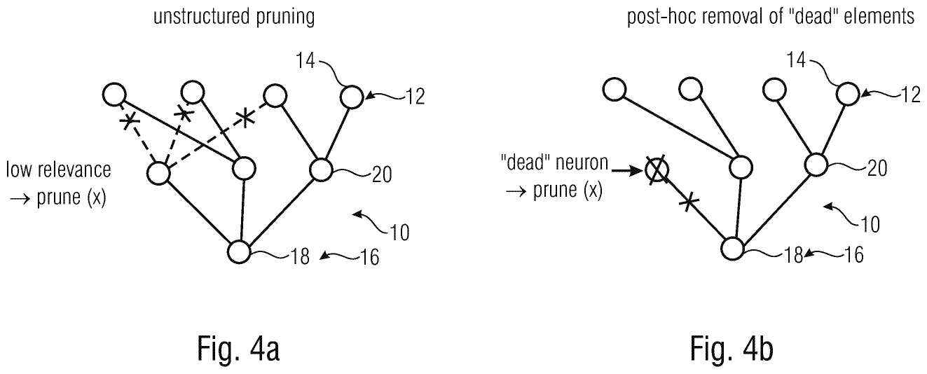

FIG. 4a or 4b illustrates one iteration of unstructured pruning, followed by a consecutive structured pruning step for efficiency, at hand of a single transformation layer of a model.

In particular, FIG. 4a shows a pruning result based on relevance scores assigned to the individual connections of the ML predictor 10, according to which certain connections, shown with dashed lines in FIG. 4a have been pruned away. As shown in FIG. 4b, one node, namely the one shown crossed-out in FIG. 4b became unconnected to the input nodes 12 owing to the pruning away of the connections of FIG. 4a (shown with dashed lines in FIG. 4a), so that same node is also pruned away along with its connection(s) to its successor node(s). Here, in the simplified example of FIG. 4b, merely one node is pruned away as such a post-hoc removal step, because the successor node is an output node 18, but naturally, it might happen that more than one node is subject to a such a post-hoc removal step.

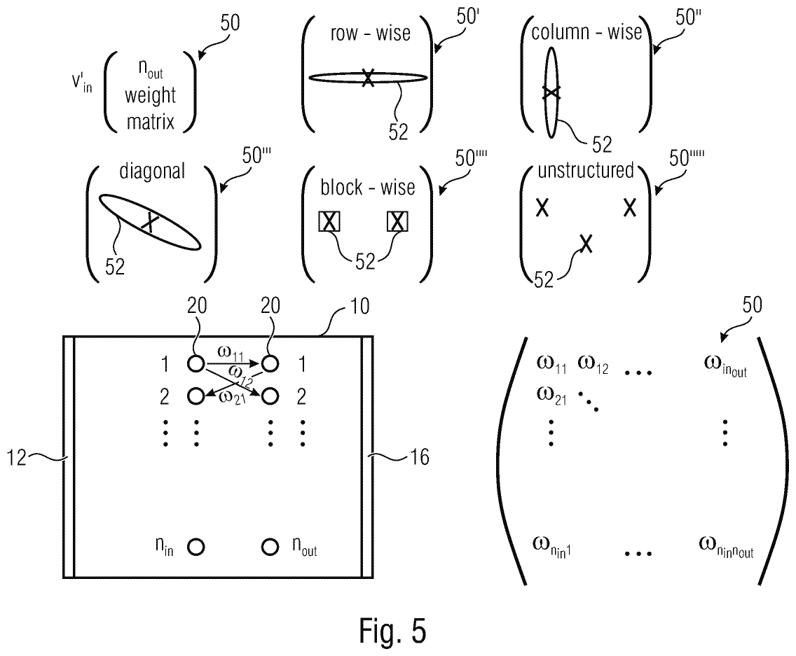

Structured pruning defines the removal of model elements defining or affecting the overall model architecture, such as individual neurons, filter channels, tensor slices. Furthermore, we define as structured pruning the removal of groups of model elements selected by structured aggregation of individual parameter relevance scores, i.e. entire rows or columns of weight matrices which is—equivalent to pruning neurons—or block structures from within a weight matrix. Different possibilities for structured pruning are illustrated in FIG. 5, contrastively to unstructured (weight) pruning.

In particular, FIG. 5 illustrates the representation of an ML predictor 10, here a layered network, by way of a matrix 50 which describes the weights w_{i,j} which connects the i^{th} node 20 of a layer with the j^{th} node of a, in inference/propagation direction leading from the input interface 12 to the output interface 16, subsequent layer. The matrix 50, thus, has nₒᵤₜ columns, i.e., the number of nodes of the subsequent layer, and nᵢₙ rows i.e., the number of nodes of the layer upstream to the former layer. As indicated at 50′, the portion 52 for which a relevance score may be determined and which may be subject to a decision whether same is pruned, for instance, may refer to a row matrix 50′. As shown at 50″, the portion 52 may be a column. As shown at 50′″, the portion 52 may relate to the weights associated with a diagonal of matrix 50. And is shown at 50″″, the portion 52 may be a square or rectangular block or sub-block out of matrix 50, or a set of such squares or rectangles. Compared thereto, as shown at 50′″″, individual weights corresponding to individual connections might form portions 52 with respect to which relevance scores are determined individually and which are individually subject to a decision about pruning or not. Pruning would, thus, lead to a corresponding zero setting of corresponding weights in matrix 50, and such weights, which are pruned away or, optionally, also those having been quantized to zero, would also not be available for an adaptation any longer in a process of, for instance, subjecting the correspondingly pruned ML predictor 10 again to some subsequent training as described further below. Rather, the corresponding connections corresponding to such pruned away and zero set weights would be removed from the architecture of the ML predictor 10 and would, thus, no longer be available in the degree of freedom of an optimization process in retraining the pruned ML predictor 10.

Structured pruning is not limited to neural network type architectures. For instance, the matrix 50 shown may be a collection of interconnection functions mᵢⱼ. Further, although dense layer or fully-connected layers are illustrated in FIG. 5, convolutional layers may be subject to structured pruning as well. Structured pruning might also be applied to support vector machines by removing SVM input dimensions (similar to RFE [5]), unimportant intermediate mapping dimensions corresponding to e.g. visual prototypes as commonly used in Bag-of-Words based computer vision models [3]. In our application, pruning criteria for structured pruning are the relevance quantities Rᵢ^{(l)} as defined in equation (2).
Pruning criteria can be aggregations (sum, avg) over multiple given sample inputs
In macro structures such as (convolutional) neural network filter banks, pruning criteria can be aggregated (naturally; for LRP) over the element ensembles considered for removal, e.g. filter layers or slices.
The filtering of only positive or negatively signed criteria might be desirable in order to achieve specific effects during the pruning process.

The pruning of elements defining overall model structures might be connected to post hoc unstructured pruning steps, e.g. when pruning neurons from fully connected neural network layers, all connected incoming and outgoing weights are to be removed as well, without further affecting (beyond removal of the neuron itself) the model behavior.

FIGS. 3a to 3b illustrate structured model pruning, i.e. the removal of structure defining elements from the model, such as individual dimensions or neurons.

Combinations of the aforementioned types of pruning are considerable and may even be advantageous. For instance, most common hardware platforms such as CPUs and GPUs cannot process unstructured sparse graph representations efficiently. Therefore, structured pruning is a recommended approach in order to reduce the complexity for performing inference on such platforms. However, usually one is able to achieve higher compression ratios if unstructured pruning is applied instead. By combining structured and unstructured pruning we may be able to achieve a desired trade-off between memory complexity and computational efficiency for particular use cases.

An example of a combined approach could be as follows.
1. Firstly, a relevance determination is performed such as LRP, on a validation set of inputs 38 in order to obtain relevance scores for portions of the ML predictor 10 and, accordingly, rank the portions according to their importance. For instance, the determination could be done for each weight of the ML predictor which may be a neural network.
2. The portions may then be aggregated to form new portions such as portions collecting weights relating to the inbound connections of a certain neuron or network node which could be applied in case of the neural node being part of a fully connected layer, or filters formed by a convolutional layer and pertaining to, for instance, a certain sub-block of a weight matrix 50. In this manner, a structured pruning criterion could be applied in order to prune unimportant neurons or filters such that a desired model reduction versus accuracy trade-off might be achieved. This step aims to maximally reduce the complexity of performing inference, thus, attaining reductions of energy and/or run time costs when the ML predictor is deployed on CPUs or GPUs.
3. Optionally, the relevance score determination or LRP could be performed or applied again. This could be done, for instance, by using the pruned ML predictor representation 46 to perform one or more further inferences on one or more further input examples 38 and deriving relevance scores based thereon and to use the resulting relevance scores 44 to reassess the importance of the portions of the non-pruned remainder of the architecture of the ML predictor 10, namely the remaining weights in case of using the weight representation for representing the ML predictor 10.
4. Unstructured pruning may then be applied onto the remaining weights, namely based on the newly determined relevance scores for the remainder of the ML predictor, in order to achieve further reductions in memory complexity.

That is, briefly referring back to FIG. 2, as shown by dotted lines 70, the apparatus 30 may operate iteratively. After performing each iteration, the representation 32 of the ML predictor 10 valid at the start of the respective iteration is replaced by the result of the actual pruning and/or quantization performed by processor 36, i.e., by the result 46, i.e., the pruned and/or quantized ML predictor or representation thereof. A first iteration where the portions underlying the relevance score determination of determinator 34 and the subsequent pruning and/or quantization relate to individual nodes, filters, certain layers or other architectural structures of the ML predictor 10, may be followed by another iteration where the portions at which the relevance score determination is performed and at which the pruning and/or quantization decisions are performed, pertain to individual connections or weights of the ML predictor 10.

The structured and unstructured pruning just described involves, in accordance with an embodiment of the present application, thresholding. Predetermined portions of the ML predictor—namely connections in case of unstructured pruning and modes or other architectural structures of the ML predictor in case of the structured pruning—whose relevance according to the relevance score determined for the predetermined portions is lower than a predetermined threshold, are pruned away. Alternatively, a ranking among portions of the ML predictor according to their relevance scores may be performed with pruning away those portions belonging to a predetermined fraction of lowest-relevance portions of the ML predictor. In addition to pruning away portions of the ML predictor whose relevance according to the relevance score determined for the predetermined nodes fulfills a predetermined criterion, further portions may be pruned away which contribute to an output of the ML predictor via the former portions exclusively, thereby having become “superfluous”.

In all the above pruning scenarios we may iterate between pruning and retraining, may thus apply an iterative algorithm that is able attain better accuracy-vs-pruning trade-offs. One iteration consists on the following steps: define a threshold ε or a percentage of parameters to be pruned, then
1. Apply relevance score determination such as LRP in order to assess the relevance of each component of the model.
2. Prune parameters according to relevance criteria (structured or unstructured). For example, prune parameters whose relevance are below a E, or prune the specified percentage of parameters with lowest relevance scores.
3. Retrain non-pruned parameters in order to compensate for the pruning error.

One can perform several of such iterations in order to attain high accuracy-vs-compression performance.

That is, look at FIG. 2 where it is shown by dashed lines that the apparatus 30 may further comprise a retrainer 80 which receives the pruned and/or quantized ML predictor 46 or the representation thereof and subject the remainder thereof, i.e., the non-pruned away portion of the ML predictor 10 or non-quantized-to-zero portion of the ML-predictor 10 according to representation 46, to a training based on certain training data such as a k-means or other optimization algorithm in order to obtain a pruned and/or quantized and re-trained ML predictor 10 or representation thereof 82.

Advantageously, in case of having pruned the ML predictor 10, the retraining is performed on a reduced ML predictor being computationally less complex and involving less parameters which form the degree of freedom for the optimization algorithm underlying the retraining. The retrained version of the ML predictor 10, namely 82, may then be, as just-outlined and as depicted in FIG. 2 by way of dashed lines, be used to substitute the foregoing version 32 of the ML predictor 10 in order to start a new iteration anew, i.e., applying the ML predictor 10 defined according to representation 82, onto input examples 38 anew, within performing pruning and/or quantization of the ML predictor 10, thus, defined according to 82, on the basis of relevance scores determined by the determinator 34.

In the following we will describe how we can generalize the concept of “pruning unimportant ML predictor portions or weight” into a more general notion.

From a source coding point of view, pruning can be interpreted as a very particular type of quantization scheme. Namely, pruning can be defined as a mapping which assigns to a set of selected parameters the value 0. However, this is entirely equivalent to having a codebook entailing the unique value 0 and quantizing the parameters according to some selection criteria. This notion can be trivially generalized to codebooks containing several values, and quantizing each parameter element of the model into a respective codebook value according to some criteria.

The entropy-constrained K-means algorithm, also sometimes referred to as the Lloyd algorithm in the literature [19], is able to find the Pareto-optimal quantization map which trades offs the bit-size of the parameter value against the distortion error induced by the quantization. Usually, a distance measure between the quantized and unquantized values is used as distortion measure (e.g., the mean squared error (MSE)), and the quantization map is accordingly optimized. However, this distortion measure does not adequately reflect the error induced into the prediction performance of the machine learning model, in particular at low bit-sizes. Hence, in order to be able to attain high compression gains, it is of high importance to be able to adequately rank each weight element according to its potential impact on the prediction of the model when its values are being quantized.

By definition, LRP ranks each weight element value according to its “relevance” for the prediction of the model. That is, higher scores mean that the particular parameter value is highly relevant for the model's decision, and should therefore not be much distorted. Analogously, lower scores mean that one should be able to perturb the respective values more strongly without much affecting the decision of the model.

Therefore, an extended version of the traditional Lloyd algorithm is described where the distortion measure is weighted according to the respective relevance score, in order to take the impact of quantization into the prediction accuracy into account.

For instance, if an entropy-constrained scalar quantization on the weight parameters of a neural network is desired, an extension of the Lloyd algorithm would then aim to minimize the following Lagrangian:

$${min}_{k} {R}_{i ← j}^{( l , l + 1 )} d ( {w}_{ij}^{l} , {q}_{k} ) + λ {l}^{′} ( {q}_{k} ) ∀ i , j , l \qquad ( 3 )$$

where wᵢⱼ^{l} denotes the ij-th weight parameter of the l-th layer of a neural network, R_{i←j}^{(l,l+1)} the respective relevance score, the relevance associated with the connection to which the weight wᵢⱼ^{l} belongs, qₖ the quantized value, d(⋅,⋅) the distance measure and ĺ(⋅) the code-length (or bits) of the quantized value.

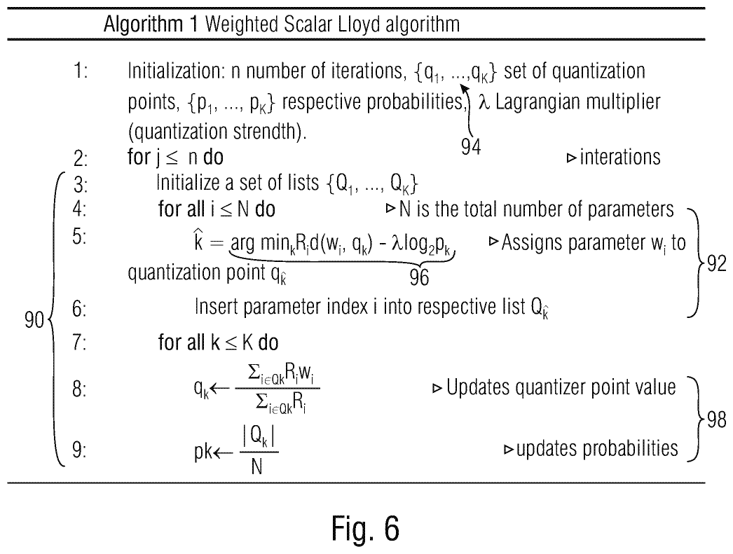

(3) can be minimized by applying the same iterative approach as the traditional Lloyd algorithm, however, with the only difference that we accordingly weight the distortion measure. Algorithm 1 in FIG. 6 displays an example of a weighted Lloyd algorithm for the example case of finding the optimal scalar quantizer. However, this can be trivially extended vector quantizers.

That is, other than described before, where the processor 36 was described as pruning the current version 32 of the ML predictor 10 at the granularity defined by the afore-discussed “portions” such as by sorting the portions of the ML predictor 10 according to their determined relevance scores and pruning away a predetermined fraction of portions being of lowest relevance, or pruning away portions having a relevance score lower than a predetermined threshold, processor 36 may alternatively use the relevance cores assigned to certain portions of the ML predictor 10 such as the weights associated with node-interconnection of the ML predictor 10, for steering a quantization coarseness in quantizing the ML predictor 10 according to an optimization aim or cost function. In particular, the latter is defined in manner so that same depends on, or increases with, increasing distance of the quantized representation of the ML predictor 10 compared to the not yet quantized version 32 thereof, with a distance weighted according to the assigned relevance scored assigned to the various portions of the ML predictor 10. Additionally, the optimization aim or cost function may depend on, or decreases, with a code length of the quantized representation defined, for instance, by the negative logarithm of the probability of the quantized value of each parameter of the representation of the ML predictor 10 which forms, or contributes to, the degree of freedom in the optimization process. The optimization process may be a k-means algorithm as depicted in FIG. 6. The optimization may be done iteratively. For each iteration 90 of the k-means clustering, a cluster formation may be performed at 92. Here, each node interconnection, or alternatively speaking, its weight is associated with one of a plurality 94 of quantization values qᵢ so as to reduce the optimization function 96. Here, pₖ denotes the fraction of current occurrences of quantization weight value qₖ, i.e. the fraction of weights belonging to set of weights Qₖ whose weight has been quantized to qₖ so far, compared to all weights. −log₂ pₖ is the code length for quantization value qₖ, and X a Lagrange parameter, Rᵢ the relevance score associated with a current node interconnection i having associated therewith weight wᵢ and d( . . . , . . . ) is a function yielding the distance between the undistorted or unquantized weight wᵢ and a currently tested quantization value qₖ. \hat{k} indexes the quantization value leading to lowest quantization cost, and accordingly, in step 92, each node i is associated with quantization value q_{\hat{k}}. It follows the quantizer update step 98 where for each quantization value of the K available quantization values the respective quantization value qₖ as well as the relative fraction of occurrence pₖ are updated. The updating updates each quantization value qₖ using a weighted sum of the unquantized weights wᵢ of the ML predictor's interconnection nodes i associated with the respective quantization value k, weighted with a relevance score Rᵢ determined for the respective predictor node interconnection i, normalized by dividing the weighted sum by a sum over all relevance scores of all node interconnections associated with the respective quantization value qₖ.

We can extend in a similar manner the iterative algorithm presented above where we iterated between pruning and retraining. Again, the main motivation behind retraining is to recover the error induced by the quantization step, therefore attaining higher compression-vs-prediction performances. One iteration would then be composed by the following steps: given a thresholds or a percentage

1. Apply relevance score determination such as LRP in order to estimate the relevance of each parameter.

2. Apply the Lloyd algorithm in order to find the optimal quantization points and quantization assignments.

3. Quantize values whose Lagrangian are lower than ε or the percentage of parameters that have lowest Lagrangian value.

4. Retrain non-quantized values in order to recover the induced quantization error.

That is, the k-means clustering could be done iteratively with, after each iteration, accepting the quantized weights for predictor node interconnections for which the acceptance increases the optimization function less than a predetermined threshold or less than a predetermined fraction of remaining unquantized weights, wherein, at the end of each iteration, the ML predictor is re-trained with respect to unquantized weights for which no quantized weight has yet been accepted. Naturally, merely one pass of above steps may be performed.

In this case, we may also fine-tune/retrain the non-zero quantization points in order to adapt their values to the particular task.

It should be noted at that some previous works have already proposed weighted versions of the Lloyd algorithm in order to take the impact of quantization on to the prediction of the model into account. Similarly to [12, 7, 14], [4] proposed a Taylor-based importance measure in order to weight the distortion in the Lloyd algorithm. Concretely, [4] propose to weight the distortion according to the diagonals of the Hessian respective to the weight element. In contrast, [15] adopts a magnitude-based approach, and weights the distortion according to the square of the respective weight value.

The above embodiments, however, use the relevance score in order to characterize the importance of the weights and for example weight the distortion in the Lagrangian, which come with the aforementioned advantages compared to the other methods.

Several use cases for meaningful model pruning shall be briefly presented below.
1. Pruning for model compression: The goal of model compression, i.e. the minimization of its description length, can be obtained by pruning away non-essential elements of the model. Here, a combination of structured and unstructured pruning approaches might be sensible, for the removal of whole filters or parts of weight matrices. Instead of rigorously pruning away non-essential model elements, one might also consider the strategy of quantizing non-essential weights (i.e. selectively representing non-essential model elements with lower numerical precision)
2. Pruning for model efficiency: The goal of minimizing inference time involved in computing predictions from the model can be obtained by minimizing the number of FLOPS involved in the inference operation. Here, we can simply remove the least relevant parts of the model (i.e. structured pruning: removal of filters from the convolutional stack of a deep neural network model) in order to avoid computations which do not (significantly) affect the prediction outcome. A reduction of FLOPS that may be used also implies a reduction of energy consumed for the computations involved.
3. Pruning as an approach to transfer learning: Transfer learning or fine-tuning describes the process of adapting a (neural network) model towards a related, yet slightly different task. Transfer learning, however, is often connected to still considerable training efforts and thus involves sufficient amounts of data for optimizing the model parameters present at start of the training process for solving the actual problem. In case the quantity of training data is lacking, or computational resources and/or time for re-training the model are scarce, elements of the models may be pruned away in order to attune its transformations to the data distributions of the target setting.
4. Pruning for sub-model extraction: There are large publicly available model libraries containing pre-trained models capable of solving complex prediction tasks, i.e. the 1000-way classification problem of the ImageNet challenge. These models are free to download and use for one's own inference tasks. However, oftentimes these models are over-proportioned for many application settings: Assume an application, which should be able to distinct between images of cats and images of dogs. In such a case, one could resort to one of the many highly performing and publicly available models and avoid the necessity of training such a predictor in the first place. However, if one's interest only lies within the distinction of cats and dogs, then all class outputs not representing cats and dogs—as well as all learned transformations leading to representations unrelated to cats and dogs—are not of interest in the considered application setting and can be pruned from the model, reducing the memory footprint and computational complexity of the model to better align to the intended problem at hand.

That is, related to item 3, FIG. 2 may be seen as such an apparatus which retrieves the definition of representation 32 of the ML predictor 10 from a server. For instance, the apparatus of FIG. 2 may be implemented on a mobile device such as user entity of a cellular network. Once retrieved from the server, the ML predictor 10 defined according to 32 is applied onto local input data 38 so as to perform one or more inferences. Then, this representation 32 is replaced by the pruned and/or quantized version 46 of the ML predictor 10 and further input data gathered, for instance, after the replacement of representation 32 by representation 46, are performed or furnished by the newly defined ML predictor 10, namely the one having been pruned and/or quantized according to 46. As described above, this procedure might end-up into an ML predictor 10 which shows even improved inference results compared to the ones retrieved ML predictor 32 although no real training had to be done. In even other words, even though the retrieved ML predictor 10 from the server might have been obtained by thorough optimization based on a huge amount of training data, the pruned and/or quantized representation 46 might end-up into an ML predictor 10 better adapted to the local statistics of input data with which the ML predictor 10 is fed from the replacement by the pruned and/or quantized version 46 onwards.

Likewise, the ML predictor 10 and its representation 32 at which the pruning and/or quantizing based on the relevance score starts may be been obtained by the apparatus of FIG. 2 in the following manner explained above in item 4: a general ML predictor 10 might have been retrieved from a server by the apparatus 2 such as an ML predictor 10 having a huge amount of output nodes 18. The apparatus 2 then removes portions of the ML predictor 10 exclusively interconnected to one or more predetermined uninterested output nodes 18 of the ML predictor to obtain the actual ML predictor 10 and its representation 32 on the basis of which the aforementioned pruning and/or quantization starts. Here, again, the pruning and/or quantization on the basis of relevance scores somehow forms a “substitute” for a pure and computationally complex retraining of the ML predictor 10 after having been freed from portions being non-interesting.

It should be emphasized that above embodiments are not limited to neural network type predictors only. In principle, the embodiments can also be used for non-neural net models. The relevance score assignment can in principle be applied to any model which can be described as a (directed) graph, and for such machine learning predictors the embodiments are applicable. We make use of this fact here by referring to machine learning predictors/models in general, in addition to sometimes mentioning neural networks.

Further, it is noted that the present embodiments are not restricted to the removal of neurons and connections in between neurons.

Rather, with respect to structured pruning and unstructured pruning alongside associated post-hoc pruning steps several additional details were described which exceed the pure removal of portions.

The description of structured pruning, for example, covers the removal of individual neurons or (intermediate) feature dimensions, which in dense layers for example, affects the overall structure of the model, but it has been additionally described that a meaningful aggregation of groups of model components (neurons, nodes, dimensions, (weighted) connections) may be performed, thereby leading to larger portions forming the units at which relevance score determination and pruning is performed. Correspondingly, their removal is considered and conducted as a (structured) unit. Further, for non-neural-network type models, for example, a removal of irrelevant mapping output dimensions of arbitrary mapping functions has been described. Furthermore, structural removal of parameter groups from the model, for example, has been described, by mentioning structurally meaningful groups of weighted connections from a neural network layer, without compromising the overall structure of neuron groups and neuron layers.

The unstructured pruning approach described above corresponds to the removal of (individual) (weighted) connections between nodes of a neural network graph. An attribution of relevance towards connections between nodes/neurons/dimensions as R_{i←j}^{(l,l+1)} has been used here.

For both the structured and unstructured pruning, a post-hoc complementary unstructured and structured pruning step has been described to further optimize/reduce the model structure without affecting its functionality, based on preceding structured and unstructured pruning steps.

Above embodiments also pertained to an application case of fine tuning a model towards another task by pruning from the model as an alternative to fine-tuning (further training) the model. Here, this application case can be imagined as an appropriate combination of structured and unstructured pruning steps. It is entirely thinkable that this optimization restricts itself merely towards the elimination of—for the intended application of the model—undesired outputs and learned feature transformations and mappings related to that outputs (i.e. a cat-vs-dog classifier probably does not require feature transformations attuned to the representation of cars and airplanes). It is also thinkable that this optimization by pruning may see application in attuning the model—while keeping all output classes—to the data distribution and characteristic statistics of another test set or application domain. This may range from adapting photographic image domain to another photographic image domain (where e.g. the camera has changed), to an adaption from complex photographic image domain to a completely different data domain (e.g. hand written digit recognition) by “trimming the model into shape”. This case assumes that the initial model is of high enough capacity in order to implement such step, and that the solution to the target problem is “somewhere in there” in the original model. Other transfers from problem domain to problem domain are also thinkable.

Thus, purposed pruning strategies have been presented above. Some embodiments related to the use of specific parameterizations of LRP for the computation of relevance score values for model elements, determined by past results and observations. Some embodiments embed the pruning into an iterative cycle of model pruning and (re) training.

Some embodiments relate to a weighted rate-distortion optimization of the weight parameters. To recall, with weighted rate-distortion optimization we mean a process that maps a particular weight parameter, say wᵢⱼ, on to a quantized value qₖ that minimizes the

$${min}_{k} {η}_{ij} d ( {w}_{ij} , {q}_{k} ) + λ {R}_{ijk}$$

where qₖ are the quantized values and Rᵢⱼₖ their respective bit-sizes. In particular, Rᵢⱼₖ may measure the bit-size with regard to the entropy of the empirical probability mass distribution of the quantized values. As to the parameter ηᵢⱼ, the embodiments use the relevance score value of the weights.

Finally, it is noted that the ML predictor which the embodiments of the present application are suitable for, are not restricted to any kind of network, adapted to any kind of inference task. The input data which the ML predictor is designed for, may be picture data, video data, audio data, speech data and/or textural data and the ML predictor may be, in a manner outlined in more detail below, ought output values which are indicative of certain characteristics associated with this input data such as, for instance, the recognition of a certain content in the respective input data, such as in the picture data and/or the video data. For instance, the ML predictor may perform an inference as to whether the picture and/or video shows a car, a cat, a dog, a human, a certain person or the like. The ML predictor may perform the inference with respect to several of such contents. Further, the ML predictor 16 may be trained in such a manner that the one or more output nodes are indicative of the prediction of some user action of a user confronted with the respective input data, such as the prediction of a location a user is likely to look at in the video or in the picture, or the like. A further concrete prediction example could be, for instance, a ML predictor which, when being fed with a certain sequence of alphanumeric symbols typed by a user, suggests possible alphanumeric strings most likely wished to be typed in, thereby attaining an auto correction and/or auto-finishing function (next-word prediction) for a user-written textual input, for instance. Further, the ML predictor such as a neural network could be predictive as to a change of a certain input signal such as a sensor signal and/or a set of sensor signals. For instance, the ML predictor could operate on inertial sensor data of a senor supposed to be borne by a person in order to, for instance, inference whether the person is walking, running, climbing and/or walking stairs, and/or inferencing whether the person is turning right and/or left and/or inference as to which direction the person and/or a body of his/her body is moving or going to move. As a further example, the ML predictor could classify input data, such as a picture, a video, audio and/or text, into a set of classes such as ones discriminating certain picture origin types such as pictures captured by a camera, pictures captured by a mobile phone and/or pictures synthesized by a computer, ones discriminating certain video types such as sports, talk show, movie and/or documentation in case of video, ones discriminating certain music genres such as classic, pop, rock, metal, funk, country, reggae and/or Hip Hop and/or ones discriminating certain writing genres such as lyric, fantasy, science fiction, thriller, biography, satire, scientific document and/or romance.

In addition to the examples set out so far, it may be that the input data which the ML predictor is ought to operate on is speech audio data with the task of the ML predictor being, for instance, speech recognition, i.e., the output of text corresponding to the spoken words represented by the audio speech data. Beyond this, the input data on which the ML predictor is supposed to perform its inference, may relate to medical data. Such medical data could, for instance, comprise one or more of medical measurement results such as MRT (magnetic resonance tomography) pictures, x-ray pictures, ultrasonic pictures, EEG data, EKG data or the like. Possible medical data could additionally comprise or alternatively comprise an electronic health record summarizing, for instance, a patient's medical history, medically related data, body or physical dimensions, age, gender and/or the like. Such electronic health record may, for instance, be fed into the ML predictor as an XML (extensible markup language) file. The ML predictor could then be trained to output, based on such medical input data, a diagnosis such as a probability for cancer, a probability for heart disease or the like. Moreover, the output of the neural network could indicate a risk value for the patient which the medical data belongs to, i.e., a probability for the patient to belong to a certain risk group. Likewise, the input data which the ML predictor is trained for, could be biometric data such as a fingerprint, a human's pulse and/a retina scan. The ML predictor could be trained to indicate whether the biometric data belongs to a certain predetermined person or whether this is not the case but, for instance, the biometric data of somebody else. Moreover, such biometric data might also be subject to the ML predictor for sake of the ML predictor indicating whether the biometric data suggests that the person which the biometric data belongs to a certain risk group and even further, the input data for which the ML predictor is dedicated could be usage data gained at a mobile device of a user such as a mobile phone. Such usage data could, for instance, comprise one or more of a history of location data, a telephone call summary, a touch screen usage summary, a history of internet searches and the like, i.e., data related to the usage of the mobile device by the user. The ML predictor could be trained to output, based on such mobile device usage data, data classifying the user, or data representing, for instance, a kind of personal preference profile onto which the ML predictor maps the usage data. Additionally or alternatively, the ML predictor could output a risk value on the basis of such usage data. On the basis of output profile data, the user could be presented with recommendations fitting to his/her personal likes and dislikes.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are advantageously performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] Sajid Anwar, Kyuyeon Hwang, and Wonyong Sung. Structured pruning of deep convolutional neural networks. ACM Journal on Emerging Technologies in Computing Systems (JETC), 13(3):32, 2017.
[2] Sebastian Bach, Alexander Binder, Grégoire Montavon, Frederick Klauschen, Klaus-Robert Müller, and Wojciech Samek. On pixel-wise explanations for non-linear classifier decisions by layer-wise relevance propagation. PLOS ONE, 10(7):e0130140, 2015.
[3] Alexander Binder, Wojciech Samek, Klaus-Robert Müller, and Motoaki Kawanabe. Enhanced representation and multi-task learning for image annotation. Computer Vision and Image Understanding, 117(5):466-478, 2013.
[4] Yoojin Choi, Mostafa El-Khamy, and Jungwon Lee. Towards the limit of network quantization. CoRR, abs/1612.01543, 2016.
[5] Isabelle Guyon, Jason Weston, Stephen Barnhill, and Vladimir Vapnik. Gene selection for cancer classification using support vector machines. Machine learning, 46(1-3):389-422, 2002.
[6] Song Han, Xingyu Liu, Huizi Mao, Jing Pu, Ardavan Pedram, Mark A Horowitz, and William J Dally. Eie: efficient inference engine on compressed deep neural network. In 2016 ACM/IEEE 43rd Annual International Symposium on Computer Architecture (ISCA), pages 243-254. IEEE, 2016.
[7] Babak Hassibi and David G Stork. Second order derivatives for network pruning: Optimal brain surgeon. In Advances in neural information processing systems, pages 164-171, 1993.
[8] Yihui He, Xiangyu Zhang, and Jian Sun. Channel pruning for accelerating very deep neural networks. In Proceedings of the IEEE International Conference on Computer Vision, pages 1389-1397, 2017.
[9] Hengyuan Hu, Rui Peng, Yu-Wing Tai, and Chi-Keung Tang. Network trimming: A data-driven neuron pruning approach towards efficient deep architectures. arXiv preprint arXiv:1607.03250, 2016.
[10] Sebastian Lapuschkin, Alexander Binder, Klaus-Robert Muller, and Wojciech Samek. Understanding and comparing deep neural networks for age and gender classification. In Proceedings of the IEEE International Conference on Computer Vision, pages 1629-1638, 2017.
[11] Sebastian Lapuschkin. Opening the machine learning black box with layer-wise relevance propagation. 2019. Dissertation.
[12] Yann LeCun, John S Denker, and Sara A Solla. Optimal brain damage. In Advances in neural information processing systems, pages 598-605, 1990.
[13] Hao Li, Asim Kadav, Igor Durdanovic, Hanan Samet, and Hans Peter Graf. Pruning filters for efficient convnets. arXiv preprint arXiv:1608.08710, 2016.
[14] Pavlo Molchanov, Stephen Tyree, Tero Karras, Timo Aila, and Jan Kautz. Pruning convolutional neural networks for resource efficient inference. arXiv preprint arXiv:1611.06440, 2016.
[15] Eunhyeok Park, Junwhan Ahn, and Sungjoo Yoo. Weighted-entropy-based quantization for deep neural networks. In CVPR, pages 7197-7205. IEEE Computer Society, 2017.
[16] Wojciech Samek, Alexander Binder, Grégoire Montavon, Sebastian Lapuschkin, and Klaus-Robert Müller. Evaluating the visualization of what a deep neural network has learned. IEEE Transactions on Neural Networks and Learning Systems, 28(11):2660-2673, 2017.
[17] Xu Sun, Xuancheng Ren, Shuming Ma, and Houfeng Wang. meprop: Sparsified back propagation for accelerated deep learning with reduced overfitting. In Proceedings of the 34th International Conference on Machine Learning-Volume 70, pages 3299-3308. JMLR. org, 2017.
[18] Wei Wen, Chunpeng Wu, Yandan Wang, Yiran Chen, and Hai Li. Learning structured sparsity in deep neural networks. In Advances in neural information processing systems, pages 2074-2082, 2016.
[19] Thomas Wiegand and Heiko Schwarz. Source coding: Part i of fundamentals of source and video coding. Found. Trends Signal Process., 4(1&#8211; 2):1-222, 2011.
[20] Ruichi Yu, Ang Li, Chun-Fu Chen, Jui-Hsin Lai, Vlad I Morariu, Xintong Han, Mingfei Gao, Ching-Yung Lin, and Larry S Davis. Nisp: Pruning networks using neuron importance score propagation. In Proceedings of the IEEE Conference on Computer Vision and Pattern Recognition, pages 9194-9203, 2018.

1. Apparatus for pruning and/or quantizing of a machine learning (ML) predictor, the apparatus being configured to
determine relevance scores for portions of the ML predictor on the basis of an activation of the portions of the ML predictor manifesting itself in one or more inferences performed by the ML predictor,
prune and/or quantize the ML predictor using the relevance scores.

2. Apparatus of claim 1, configured to
use a pruned and/or quantized version of the ML predictor which results from the pruning and/or quantizing, to perform one or more further inferences, and
recursively repeat the determining the relevance scores and the pruning and/or quantizing on the basis of an activation of the portions of the ML predictor manifesting itself in the one or more further inferences.

3. Apparatus of claim 1, configured to
subject a non-pruned-away and/or not quantized to zero portion of the ML predictor which results from pruning and/or quantizing, to training using training data.

4. Apparatus of claim 1, wherein the ML predictor comprises nodes and node interconnections and the apparatus is configured to
determine the relevance scores for the nodes and/or the node interconnections of the ML predictor by
back propagating an initial relevance score at an output of the ML predictor by
distributing a relevance score at a predetermined node of the ML predictor onto predecessor nodes of the predetermined node according to fractions which correspond to further fractions at which activations of the predecessor nodes contribute to an activation of the predetermined node in the one or more inferences.

5. Apparatus of claim 4, configured to
determine the relevance score for a predetermined portion of the ML predictor, composed of more than one node and/or node inter connection of the ML predictor by aggregating the relevance scores of the more than one node and/or node interconnection the predetermined portion is composed of.

6. Apparatus of claim 5, configured to
determine the predetermined portion by analyzing the distribution of relevance scores over the ML predictor.

7. Apparatus of claim 1, configured to, in pruning and/or quantizing the ML predictor using the relevance scores,
prune away predetermined portions of the ML predictor whose relevance according to the relevance score determined for the predetermined portions is lower than a predetermined threshold.

8. Apparatus of claim 1, configured to, in pruning and/or quantizing the ML predictor using the relevance scores,
prune away predetermined first portions of the ML predictor whose relevance according to the relevance score determined for the predetermined nodes fulfills a predetermined criterion, and second portions which contribute to an output of the ML predictor via the first portions exclusively.

9. Apparatus of claim 7, configured to, in pruning and/or quantizing the ML predictor using the relevance scores,
perform the pruning away so that the predetermined threshold decreases towards an output of the ML predictor.

10. Apparatus of claim 1, configured to, in pruning and/or quantizing the ML predictor using the relevance scores,
prune away predetermined portions of the ML predictor whose relevance according to the relevance score determined for the predetermined portions is lower than the relevance of more than a predetermined fraction of portions of the ML predictor.

11. Apparatus of claim 1, configured to
prune and/or quantize the ML predictor using an optimization scheme with an objective function which depends on a weighted distance between quantized weights and unquantized weights of the ML predictor, weighted based on the relevance scores.

12. Apparatus of claim 11, wherein
the objective function depends on a sum of the weighted distance and a code length of the quantized weights.

13. Apparatus of claim 11, wherein
the optimization scheme is a k-means clustering.

14. Apparatus of claim 13, configured to
perform, for each iteration of the k-means clustering,
a cluster formation step associating each ML predictor node interconnection with one of a plurality of quantization values so as to reduce the optimization function, and
a quantizer update step updating each quantization value using a weighted sum of the unquantized weights of the predictor node interconnection associated with the respective quantization value, weighted with a relevance score determined for the respective ML predictor node interconnection.

15. Apparatus of claim 13, configured to repeat performing the k-means clustering with, after each performance, accepting the quantized weights for predictor node interconnections for which the acceptance increases the optimization function less than a predetermined threshold or less than a predetermined fraction of remaining unquantized weights.

16. Apparatus of claim 15, configured to
re-train the ML predictor with respect to unquantized weights for which no quantized weight has yet been accepted before any repetition of the k-means clustering.

17. Apparatus of claim 14, configured to
re-train the ML predictor with respect to unquantized weights for which no quantized weight has yet been accepted.

18. Apparatus of claim 1, configured to
retrieve a definition of the ML predictor from a server,
apply the ML predictor onto local input data so as to make the ML predictor performing the one or more inferences,
replace the ML predictor with a pruned and/or quantized version of the ML predictor which results from the pruning and/or quantizing and apply the pruned and/or quantized version of the ML predictor onto further input data such as replenishments of the local input data to subject the further input data to inference.

19. Apparatus of claim 1, configured to
retrieve a definition of a general ML predictor from a server,
removing portions of the general ML predictor exclusively interconnected to one or more predetermined uninterested outputs of the ML predictor to acquire the ML predictor.

20. Method for pruning and/or quantizing of a machine learning (ML) predictor, the method comprising
determining relevance scores for portions of the ML predictor on the basis of an activation of the portions of the ML predictor manifesting itself in one or more inferences performed by the ML predictor,
pruning and/or quantizing the ML predictor using the relevance scores.

21. Non-transitory digital storage medium having a computer program stored thereon to perform the method for pruning and/or quantizing of a machine learning (ML) predictor, said method comprising:
determining relevance scores for portions of the ML predictor on the basis of an activation of the portions of the ML predictor manifesting itself in one or more inferences performed by the ML predictor,
pruning and/or quantizing the ML predictor using the relevance scores,
when said computer program is run by a computer.
